(19) United States
(12) Patent Application Publication
(10) Pub. No.: US 2002/0194264 A1
(43) Pub. Date: Dec. 19, 2002

(54) Digital information distribution apparatus and method

(75) Inventors: Koichiro Uchiyama, Tokyo (JP); Duncan John Kennedy, San Francisco, CA (US)

Correspondence Address: SUGHRUE, MION, ZINN, MACPEAK & SEAS, PLLC, 2100 Pennsylvania Avenue, NW, Washington, DC, 20037-3213, US

(73) Assignee: Pioneer Corporation

(21) Appl. No.: 09/867,542

(22) Filed: May 31, 2001

(51) Int. Cl. G06F 17/60; G06F 15/16; H04N 7/173

(52) U.S. Cl. 709/203; 725/109; 725/114; 705/14

(57) ABSTRACT

A method and apparatus that provides a digital audiovisual playback system that requires only the use of a standard telecommunication device to display remotely high quality music video on-demand. The user interacts with the system via a graphic user interface (GUI) using the keypad of the telecommunication device and a communication connection through a public telephone network. The system operates in two mode of operation a “Commerical Mode” and a “Jukebox Mode”. The Commerical Mode is a continuous mode of operation and display product advertisements on a digital display device. The JukeBox Mode is initialized by the end-user calling a phone number displayed in GUI. Once a connection is established with a central database, the end-user is prompted to make music selections by using the keypad of the phone used to make the initial call. The charge for the use of the system is automatically changed to the owner of the telecommunication device.

### BACKGROUND OF THE INVENTION

1. Field of the invention

The present invention relates to an apparatus and method for providing an interactive, on-demand digital information distribution system for displaying remotely digital contents such as music and video data using a telecommunication device and a communication connection.

2. Description of the Related Art

A jukebox system, which is a machine that plays recorded music by reproducing records or optical discs that are installed in the machine, is popular in entertainment places such as bars, restaurants, etc. To request a song, a user inputs money into the jukebox and selects the desired song from a list of song titles displayed on the jukebox. The jukebox then searches through the existing song titles and selects a record or disc on which the selected song is recorded, and reproduces the song.

However, there are a few drawbacks that are associated with maintaining such a jukebox system. For example, exchanging of the records or discs is needed periodically for the purpose of adding new and fashionable songs and removing less popular songs. Furthermore, those who want to request a song have to walk to the jukebox, insert money, and select the desired song. Also, a person is needed to periodically collect the money that is put into the jukebox.

Many methods have been used to distribute digital video information. For example, some audiovisual playback systems are directed generally to video-on-demand systems that allow an end-user to download real-time audiovisual data on existing home electronic equipment for their listening and viewing pleasure. The video-on-demand concept is based primarily on host-client architecture for downloading real-time audiovisual data in very large amounts and at a very high speed. Such systems aim, for example, to provide full-length movies, with sound, to on-line subscribers. Typically, remote users communicate with large mainframe servers containing the audiovisual data.

Telephone networks have been suggested as a means of distributing audiovisual data to an end-user in Goodman et al., U.S. Pat. No. 5,010,319 and Kleinerman, U.S. Pat. No. 4,849,811, which are incorporated herein by reference in their entirety. In these references, the audiovisual data is distributed using the publicly switched telephone network (PSTN), which is often bandwidth limited and provides only still frame or video conferencing capabilities. Because telephone system carriers for the most part use the PSTN only for connectivity between subscribers, there is no capability for dynamic routing of digitized video without dedicated leased, wide bandwidth circuits.

U.S. Pat. No. 5,247,347, to Litteral et al. describes a so-called video on-demand service that provides video programming to subscribers over the PSTN. The disclosure of such patent is herein incorporated by reference. A video information provider (VIP) transmits coded digital video data over wide band PSTN supplied connectivity to a central office. The video data may be buffered at the central office for transmission over a Plain Old Telephone System (POTS) line to the subscriber. A subscriber may use either a standard telephone instrument over the PSTN or a dedicated control device over an ISDN packet network to order the video programming. Such a control device is located proximate to a television set of the subscriber and permits a display of the program menu on the television screen. Connectivity between the central office and the subscriber for transmission of video data is provided by an asymmetrical digital subscriber line (ADSL) system. ADSL interface units perform multiplexing of digital video information with voice information to be transmitted to the subscriber and support transmission on the ISDN packet data network of a reverse control channel from the subscriber to the central office. Although, the system described above improves the means of distribution of video by improving bandwidth using stationary converted or digital subscriber devices located at the home, it still requires the end-user to possess expensive in-home electronic equipment to display the audiovisual data on-demand.

Improvements in the area of video on-demand systems have been achieved using the Internet as a means of distributing the video data, as illustrated in U.S. Pat. No. 5,956,716 to Kenner et al., which is incorporated herein by reference. This prior art reference discloses a video clip and retrieval system that allow an end-user to access data from the World Wide Web (WWW) or web-like environment via the Internet. This system provides full-length music videos and movies to on-line subscribers that are played on PC terminals, which interfaces with the system. However, this video-on-demand system still involves the use of expensive and sophisticated computer and communication systems, which are adapted to feed full-length movies to subscribers on demand. In other words, such systems require that users have expensive in-home computer or electronic equipment for downloading and playing the requested audiovisual data as well as requiring the payment monthly subscription fees for utilizing the service.

U.S. Pat. No. 5,914,941 to Janky discloses a portable, playback system that slightly reduces the cost of data on-demand services. The disclosure of such reference is incorporated herein by reference. Janky discloses a subscription and on-demand audio program material from a remote source using a portable high capacity audio recorder and playback device. However, the device in Janky is, in part, a digital replacement for an audio tape recorder and cannot be utilized for video on-demand-type services.

### SUMMARY OF THE INVENTION

One object of the present invention is to overcome problems associated with the prior art. Another object of the present invention to provide a method and apparatus that provides a high-quality, digital information distribution apparatus and method that a user can operate interactively with a telecommunication device.

The present invention is a digital information distribution apparatus that comprises a digital information server which stores digital information to be distributed, at least one display device which displays said digital information, a telecommunication device which requests digital information, a first communication pass which communicates the digital information to a server and display device, a second communication pass which communicates with the telecommunication device and the digital information server,. The digital information server provides a menu for selecting digital information to be displayed on the display device through the first communication pass. A selection, based on the menu displayed, is inputted by the telecommunication device, and is sent to the digital information server through the second communication pass, and the digital information server provides the digital information based on the selection.

It is therefore, another object of the present invention to provide a method and apparatus that provides a high-quality, digital audiovisual information distribution apparatus and method that a user can operate interactively with telecommunication device.

The digital audiovisual information distribution apparatus comprises a digital audiovisual information server which stores digital audiovisual information to be distributed, at least one display device which displays the digital audiovisual information, a telecommunication device which requests the digital audiovisual information, a first communication pass which communicates with the digital audiovisual information server and the display device, and a second communication pass which communicates with the telecommunication device and the digital audiovisual information server. The digital audiovisual information server provides a menu for selecting the digital audiovisual information to be displayed on the display device through the first communication pass. A selection, based on the menu, is inputted by said mobile device and is sent to the digital audiovisual information server through the second communication pass, and the digital audiovisual information server provides digital information based on the selection .

It is yet another object of the present invention to provide a method and apparatus to correct a charge fee conveniently. The fee for using the system is charged to an owner of the telecommunication device directly.

The digital information distribution apparatus comprises a digital information server which stores digital information to be distributed, a display device which displays digital information, a telecommunication device which requests the digital information, a first communication pass which communicates with the digital information server and said display device, a second communication pass which communicates with the telecommunication device and the digital information server via the telecommunication company. The digital information server provides digital information to said display device through said first communication pass based on a selection, inputted by said telecommunication device, sent through said second communication pass, and then, a predetermined fee required to provide said digital information is charged to an owner of the telecommunication device.

### BRIEF DESCRIPTION OF THE DRAWINGS

The above and other aspects, features and advantages of the present invention will become apparent to those persons having ordinary skill in the art to which the present invention pertains from the following description taken in conjunction with the accompanying drawings or figures, wherein:

FIG. 1 is a conceptual diagram of an illustrative, non-limiting embodiment of the digital information distribution system of the present invention;

FIG. 2 is a schematic view of the embodiment of a digital audiovisual playback system of the present invention;

FIG. 3 is a conceptual diagram of the graphic user interface (GUI) and the Jukebox Mode of operation of the embodiment;

FIG. 4 is a conceptual diagram of the GUI and the Commercial Mode of operation of the embodiment;

FIG. 5 is a conceptual diagram of the GUI and both the jukebox and commercial modes of operation of the embodiment;

FIG. 6 is a flow chart illustrating the process of making a music selection using a telecommunication device of the embodiment;

FIG. 7 is a flow chart illustrating the process of adjusting system settings of the embodiment; and

FIG. 8 is a schematic diagram of another illustrative, non-limiting embodiment of the digital audiovisual playback system of the present invention.

### DESCRIPTION OF THE PREFERRED EMBODIMENTS

The following description of the illustrative, non-limiting embodiments discloses specific configurations, components, and operations. However, the embodiments are merely examples of the present invention, and thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, components, and operations of the present invention that would have been known to one skilled in the art are omitted for the sake of clarity and brevity.

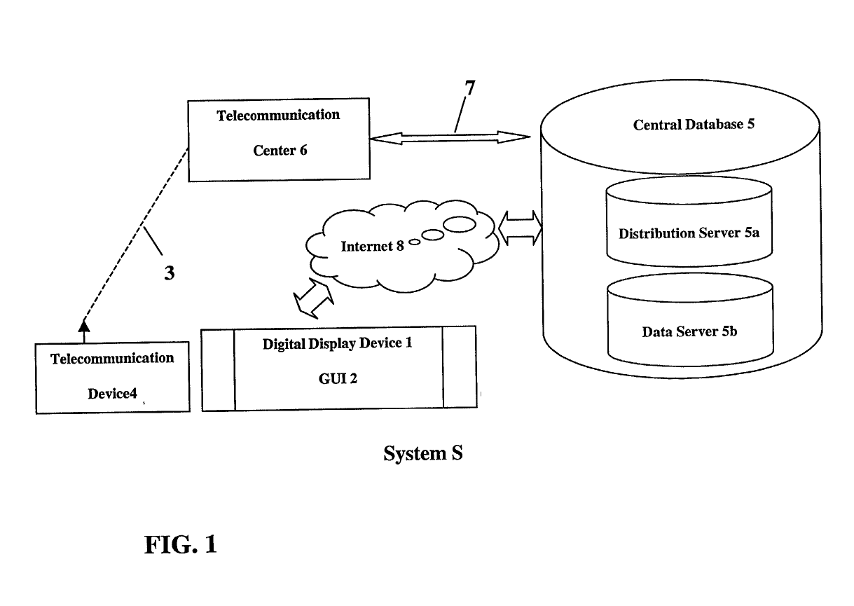

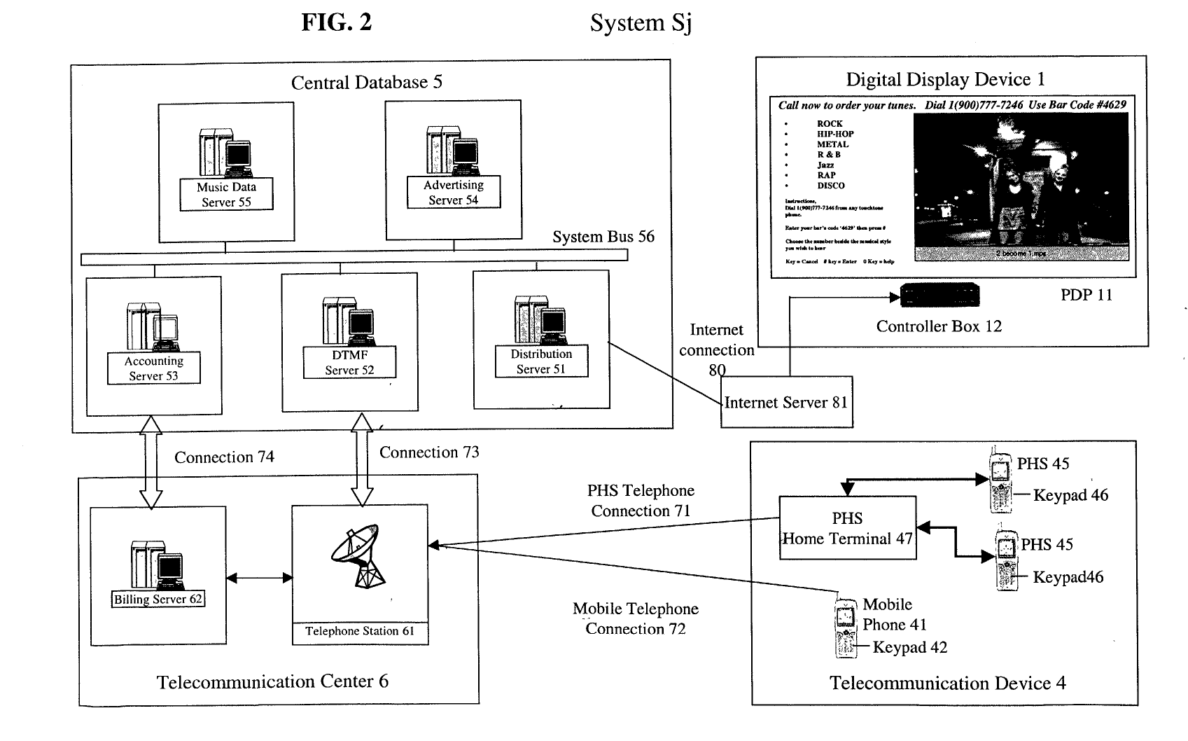

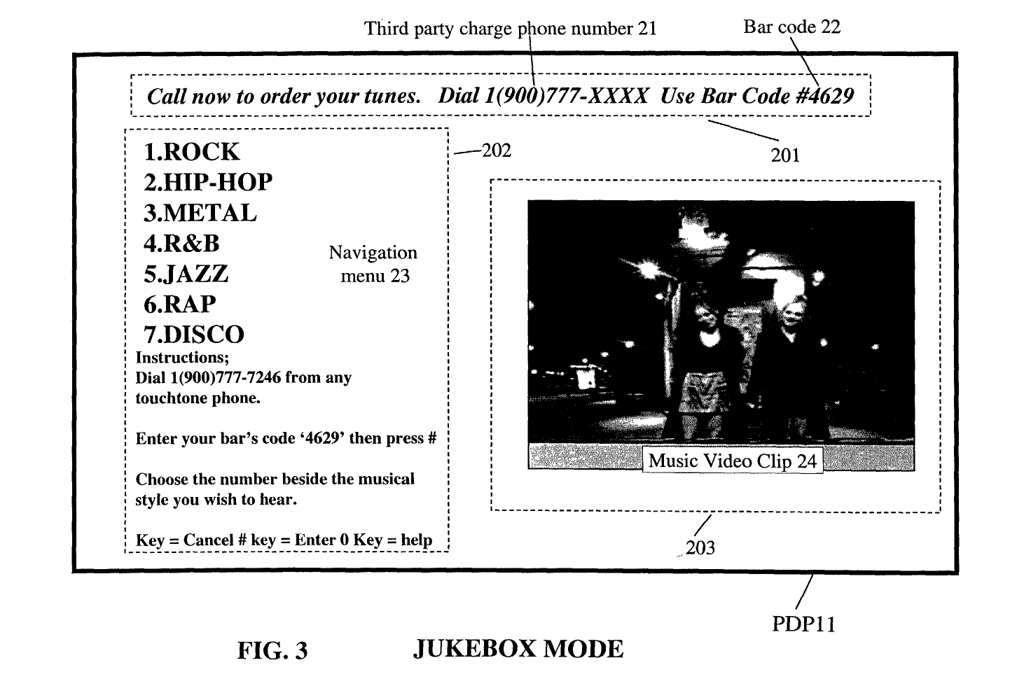

Referring to the drawings, a concept of a digital audiovisual playback system S in accordance with an illustrative, non-limiting embodiment of the present invention is shown in FIG. 1. The system S includes a digital display device 1 that is installed in a remote location open to the general public such as a bar, coffee shop, restaurant or other commercial establishment. The digital display device 1 can be a PC, television, or a plasma display panel (PDP) system that has a big and wide screen. Also, a speaker system is installed for reproducing digital audio information in the remote location. (The speaker system is not shown in FIG. 1). The display device 1 includes the use of a graphic user interface (GUI) 2 and a controller to display digital information, which will be illustrated in more detail in FIGS. 2 and 3. The GUI 2 enables the end-user to interact with the digital audiovisual playback system S for operations such as entering a menu selection, entering a number, making a decision, etc. Specifically, the GUI 2 prompts the end-user to call a telephone number displayed on the digital display device 1 in order to request digital information or audiovisual data such as a music video clip or an interactive game. The end-user then dials the number displayed via a personal telecommunication device 4 such as a mobile device. In one embodiment, the telecommunication device 4 is a standard cellular mobile telephone. The telecommunication device 4 then makes a wireless connection 3 to a telecommunication center 6, and the telecommunication center 6 is connected a central database 5 via a connection line 7. The connection line 7 can be a physical communication line, wireless transmission path, satellite transmission path, etc. In this way, the personal telecommunication device 4 is connected to the central database 5 via the telecommunication center 6. However, the end-user may also use a standard landline or fixed telephone at the commercial establishment or an Internet phone instead of the mobile phone 4.

In accordance with the present invention, if the end-user uses a fixed telephone for making the call, the call must be made using a calling card, credit card or the like to charge a fee for the requested digital information and/or for using the system S. If the end-user uses the mobile telephone, the fee is directly charged to a mobile telephone account of the end-user. The call made by the end-user utilizing the system S is routed through the telecommunication center 6, which in one example, is located in a telephone company. The call is then completed by the telecommunication center 6 and then connected to the central database 5. The database 5 contains a distribution server 5a and a data server 5b and contains the desired digital information or audiovisual data. Many digital display devices 1 can be connected to the central database 5 via a standard Internet connection 8 for displaying the requested digital or audiovisual data.

The interaction between the central database 5 of the system S and the end-user is achieved through the use of the keypad of the telecommunication device 4 possessed by the end-user. In other words, the end-user makes a music selection by using the numbers or letter on the keypad that correspond to the desired music selections displayed on the digital display device 1. The operation created with the keypad by the end-user is sent to the central database 5 via the wireless connection 3, telecommunication center 6 and communication line 7.

In response to the music selection or operation, the distribution server 5a creates a navigation menu to assist the end-user 2 in requesting particular digital information. The navigation menu is provided to the digital display device 1 via the Internet connection 8. Also, the distribution server 5a creates another navigation menu corresponding to the selection made by the end-user. After a selection is made by the end-user, the desired digital information, audiovisual data, or interactive game data is transmitted from the data server 5b in the central center 5 to the remote digital display device 1 for the end-user's reading, listening, or viewing pleasure. Once the selection for the desired digital information, audiovisual data, or game data is made by the end-user, a distribution server 5a in the central database 5 will search for such data in the data server 5b. Then, the distribution server 5a distributes the requested digital information or audiovisual data to the digital display 1 via the standard internet connection 8 such as the type offered by a local internet provider. Also, instead of the Internet connection 8, a public telephone line, which connects the digital display device 1 and the central database 5, may be used.

The fee or charge for using the system S is charged directly to the owner of the telecommunication device 4. In the case of a fixed telecommunication device, the charge for the service would then be charged directly to the owner of the calling card, credit card, etc. The charge procedure is handled by the telecommunication center 6. In a further implementation, with regards to the charge of the fee for the request of digital information, audiovisual data, game data, or using the system S, a third party toll phone number is used. The third party toll phone number is a phone number whose area code is 900, 977, etc. in the United States or 0990 in Japan. In response to calling the third party toll phone number displayed on the GUI 2 of the digital display device 1, the end-user is connected to the central database 5. The charge for the use of the system S is billed through the use of the third party billing arrangement and billed directly to the owner of the telecommunication device 4. One example of the billing aspect of the present invention will be discussed in more detail below.

In accordance with the digital information distribution system S of the present invention described above, a description of the operation of one embodiment of the audiovisual playback system (e.g. a jukebox system) will be described. If the end-user desires to play a music video clip while away from home and while present at a commercial establishment offering such a service, the end-user first dials the number displayed on the digital display device 1. The call is routed through the telecommunication device 4 to the central database 5 via the telecommunication center 6. Once a connection is established, the distribution server 5a outputs a series of menus, options, etc. to be displayed on the display device 1 via the GUI 2. As a result, the end-user is prompted to make a music selection from the selection offered by the GUI 2. For example, the end-user can select one of the music genres or types such as Rock, Hip-Hop, Metal, R & B, Jazz, Rap or Disco. The end-user makes a selection by interacting with the GUI 2 using the keypad on the telecommunication device 4 used to make the initial call. Once a final selection is made, the central database center 5 transmits the music video clip (audiovisual data) to the digital display device 1 via the internet connection 8, which is maintained by the commercial establishment owner i.e., the owner of the bar, restaurant or coffee shop. The digital display device 1 is installed in a commercial establishment and can accommodate multiple users. If there is more than one request for the display of audiovisual data, the request will be displayed sequentially in the order received.

FIG. 2 illustrates a detailed schematic of an embodiment of the digital audiovisual playback system of the present invention such embodiment relates to a jukebox system Sj.

The jukebox system Sj comprises a digital display device 1, a telecommunication device 4, a central database 5 and a telecommunication center 6. The database 5 comprises a distribution server 51, a Dial Tone Multi-Frequency (DTMF) server 52, an accounting server 53, an advertising server 54, a music data server 55, and a system bus 56, which interconnects the servers 51-55. Also, the telecommunication center 6 comprises a telephone station 61 and billing server 62.

The digital display device 1 comprises a plasma display panel (PDP) 11 with a large display surface and a controller box 12 which controls the display of digital information provided from the central database center 5 and which communicates with the central database center 5. Also, the speaker system (not shown) is installed. The jukebox system Sj has two different display modes on the digital display device 1. A first mode is a jukebox mode that mainly displays music video clips. As shown in FIG. 3, the display area on the PDP 11 has three display areas in the jukebox mode. A first area 201 is where a third party phone number 21 and a bar code number 22 are displayed, a second area 202 is where a navigation menu 23 is displayed, and a third area 203 is where a music video clip 24 is displayed under the control of the controller box 12. The information to be displayed on the PDP 11 will be provided through the Internet connection 80 via an Internet server 81 from the distribution server 51 and the music data server 55 located in the central database 5. The Internet connection 80 may be replaced by a standard telephone connection.

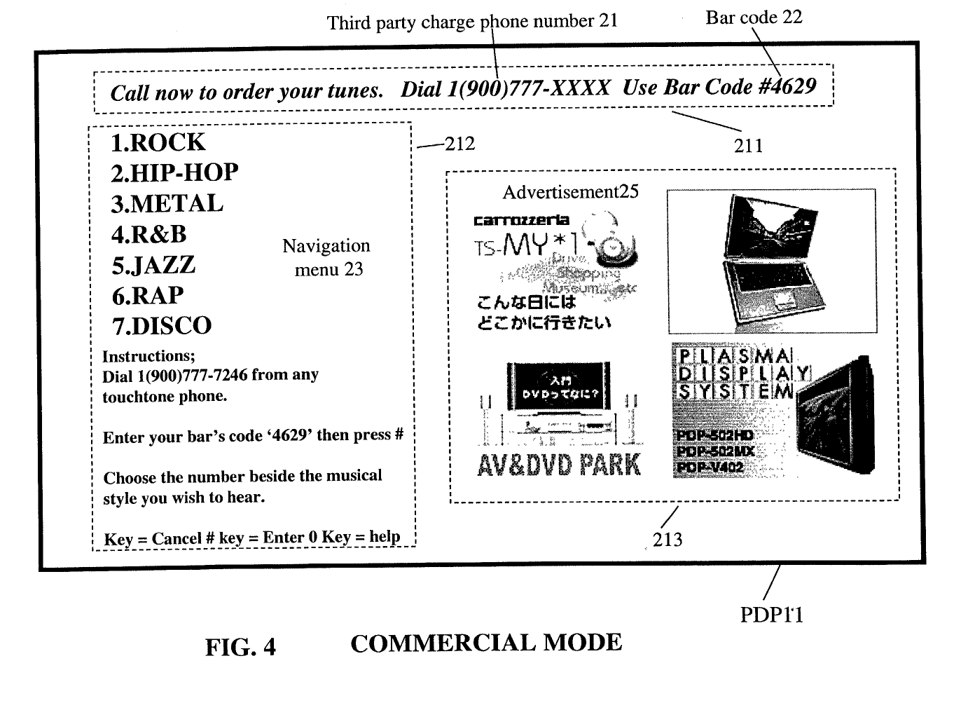

A second mode is a commercial mode that mainly displays advertisements. As shown in FIG. 4, the display area on the PDP 11 has three display areas in the commercial mode. A first area 211 is where the third party phone number 21 and the bar code number 22 are displayed. A second area 212 is where the navigation menu 23 is displayed, and a third area 213 is where an advertisement 25 is displayed under the control of the controller box 12. The information to be displayed on the PDP 11 will be provided through internet connection 80 via the Internet server 81 from the distribution server 51 and also from the advertising server 54 located in the central database 5. In FIG. 4, four advertisements are displayed. The advertisement may be a still image (a banner) and/or a moving image.

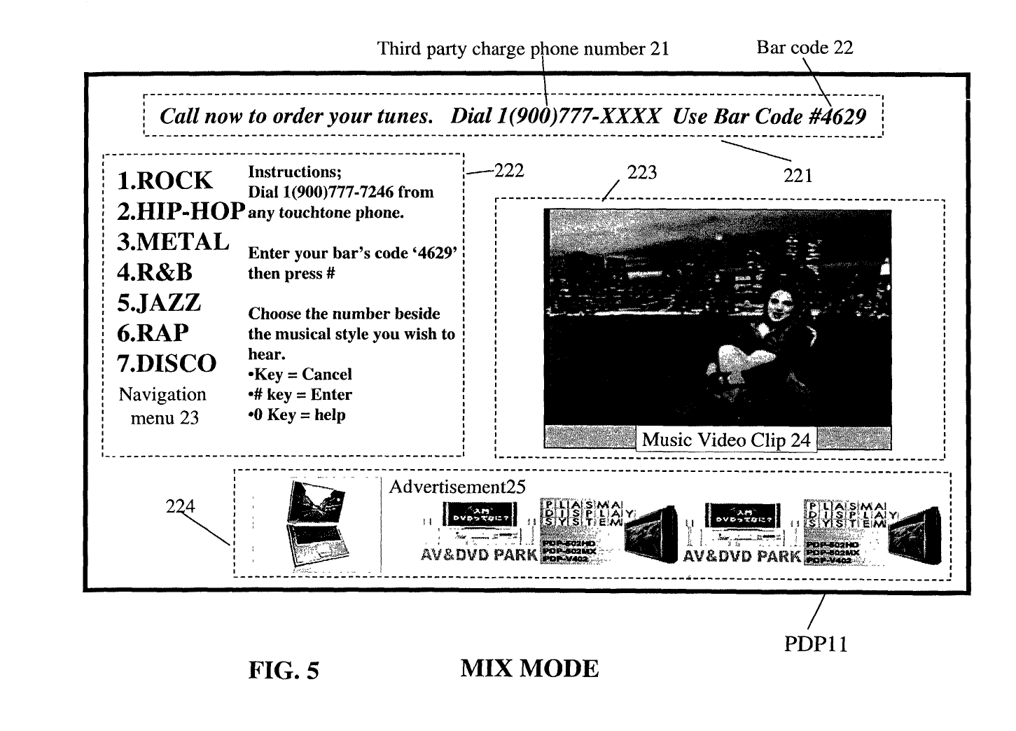

In addition to or instead of either of the two modes described above, the system Sj may operate in a mix mode. The mix mode combines music video clips 24 and advertisements 25 as shown in FIG. 5. In the mix mode, the display area on the PDP 11 has four display areas. The first area 221 is where the third party phone number 21 and the bar code number 22 are displayed. The second area 222 is where a navigation menu 23 is displayed. The third area 223 is where the music video clip 24 is displayed, and the fourth area 224 is where the advertisements 25 are displayed. The jukebox mode and the commercial mode are changed based on the predetermined program under the control of distribution server 51.

As shown in FIGS. 3-5 a mobile phone 41 (i.e. a cellular phone) with a keypad 42 or a personal handy phone (PHS) 43 with a keypad 44 may be used as the telecommunication device 4. However, the telecommunication device 4 is not limited to such devices 41 and 43, and one skilled in the art will realize that many other devices may be used.. The PHS 45 is connected to a PHS home terminal 47, which may be connected to several PHSes and which controls calls from each PHS 45. The mobile phone 41 is connected to the telephone station 61 through a mobile telephone connection 72. Also, the PHSes 43 are connected to the telephone station 61 through the PHS home terminal 47 and a PHS telephone connection 71.

In the telecommunication center 6, the telephone station 61 sends billing information, such as a calling time, a calling number, a calling date, and a song request using the jukebox system to the billing server 62. Also, the telephone station 61 transfers signals from the telecommunication device 4 to the DTMF server 52 and transfers signals (including some voice messages) from the DTMF server 52 to the telecommunication device 4. The billing server 62 manages the billing information for the user of the mobile phone 41 or PHS 45, and generates a bill that includes a calling charge and a fee for all songs requested by the user. The telephone station 61 and the DTMF server 52 are connected via a connection 73, and the billing server 62 and accounting server 53 are connected via a connection line 74.

If the end-user chooses to use the mobile phone 41, his or her call will be connected via the mobile telephone connection 72 to the telecommunication center 6 by dialing the third party charge phone number 21 that is displayed in the first area 201 of the PDP 11. Before a specific song is requested, the distribution server 51 provides a sample music video clip and the navigation menu to the digital display device 1 in the jukebox mode. Alternatively, the server 51 may provide advertisements and the navigation menu to the display in the jukebox mode. In the commercial mode, the server 51 provides advertisements to the digital display device 1. Similarly, if the end-user chooses to use the PHS 45, the call will be completed via a PHS telephone connection 71 to the telecommunication center 6. At that time, the connection 73 is made from the telephone station 61 of the telecommunication center 6 to the DTMF server 52 of the central database 5. Information about the selection entered with the keypad 42 of the mobile phone 41 by the end-user is sent to the central database 5 via the mobile telephone connection 72 and the connection 73 between the telephone station 61 and the DTMF server 52. The DTFM server 52 recognizes tone information from the mobile phone 41, and then forwards a request to the distribution server 51. Based on such information, the distribution server 51 makes a decision, searches for data, or replies to the DTFM server 52. Also, DTFM server 52 sends the reply made by the distribution server 51 to the mobile phone 41 through the connection 73 and the mobile telephone connection 72. For example, a voice message that prompts the end-user to input a next selection or instruction to select a song may be sent to mobile phone 41 as the reply. Furthermore, if the mobile phone 41 has an Internet connection feature, the distribution server 51 may provide a navigation menu for the mobile phone 41 that includes the same contents that are displayed on the PDP 11.

Upon completion of the connection between the mobile phone 41 and the central database 5 via mobile telephone connection 72 and the connection 73, the end-user is next prompted to enter the bar code 22, which is displayed in the first area 201 in the PDP 11. The bar code is an identification number that identifies the physical location of a digital display device 1. A different bar code is allocated for each of the digital display devices 1 that are installed at different locations. (If there are a plurality of digital display devices 1 in same location or are located on the same floor or same room of an establishment, such as a restaurant, a bar or coffee shop, each of the digital display devices 1 may have the same bar code.) Also, the bar code can be changed in case the location where the display 1 is installed is changed. The end-user inputs the bar code with the keypad 42 of the mobile phone 41, and the distribution server 51 recognizes which digital display device 1 is trying to select a song. Then, the end-user is prompted to select a music category (genre or style) with the keypad 42 while looking at the navigation menu 23 that is displayed in the second area 201 in PDP 11. (Clearly, other menu options or menu types besides music categories may be used to assist the end-user in selecting a song). The end-user makes a selection to request a song by pressing a number on the keypad 42. In one example, the number corresponds to the number in the navigation menu 23 displayed on the PDP 11 and relating to a music category. For example, as shown in FIG. 3 number “1” corresponds to “ROCK”, and the number “3” corresponds to “METAL”.

If more than one music video clip is selected at the same location, the selected music videos clips will be displayed sequentially based on the order of selection by the end-user(s). This selection procedure to select a song is continued until a final selection is made by the end-user. In one embodiment, after the music category is selected, the end-user inputs information such as “genre”, “artist name” or “title” to ultimately select a song. When the final selection is made, the selected music video clip 24 is transferred from the database and displayed on the digital display device 1.

Specifically, after the final selection is made, the distribution server 51 locates the requested music video clip in the music data server 55. The distribution server 51 then transmits the music video clip via an Internet connection 80 established by the Internet server 81 to the controller box 12 of the digital display device 1. The controller box 12 displays the music video clip 24 on the third display area 203 in PDP 11 so that it can be viewed by the end-user. Also, audio data of the music video clip 24 is reproduced through an amplifier and the speaker system so that it can be listened to by the end-user.

The fee for the use of the system Sj, including the fee for requesting a song (music video clip) via the third party charge phone number, is calculated by the billing server 62 in the telecommunication center 6. The billing server 62 is in communication with the accounting server 53 located in the central database 5 via the connection 74, and the account server 53 stores account information related to an end-user's usage of the system Sj, which can be accessed and verified. Also, the billing server 62 periodically generates a bill (e.g. each month), and the bill includes telephone call charges of the end-user's mobile phone 41 and the fee for the request of the song. Then, the telephone company sends the bill to the end-user.

The central database 5 also includes the advertising server 54 that contains advertisements for various commercial products, which can be transmitted by the distribution server 51 for displaying the advertisements on the third area 213 in digital display device 1 in the commercial mode or the mix mode. When there is a combined use of the juke box mode and the commercial mode, the distribution server 51 transmits commercial advertisements 25 to the digital display device 1 continuously without reproducing the music video clip 24. Also, in one implementation, the advertisement is picked up at random. When the end-user requests a song, the distribution server 51 changes from the commercial mode into the jukebox mode. In other words, the commercial mode is the idle mode of operation of the system Sj. For example, when an end-user initially approaches the digital display device 1, the system Sj is already in the commercial mode (i.e. displaying advertisements 25 on the digital display device 1). Then, when the end-user selects a song, the song is displayed on the display device 1 instead of the advertisements.

The digital display device 1 as disclosed in FIG. 2 is preferably a Plasma Display Panel (PDP) system, such as a Pioneer PDP-503, that is mounted in a commercial establishment such as a bar, coffee shop, restaurant or the like. The typical PDP for this type of application would include a plasma display panel, and a small mountable computer, and a DSL or ISDN connection for receiving data via the Internet. The computer would include a video card supporting 1280×768 resolution, an EtherNet input with 16 bit audio output, a DTMP recognition system and software, a video card, network cable 64 MB or 128 MB RAM memory and a 20 GB hard drive. The operating system of display device may be a “windows” type operating system such as Windows 2000. Other software may include Quicktime 4.0, kShell 1.0, telephony software, and remote administration software. Additionally, the software installed in the computer may also include the GUI, which would be a browser-type software such as Netscape 4.0. These specifications of the display device 1 are merely one example and does not limit the present invention.

In accordance with FIG. 3, the GUI 2 offers a telephone number to be called by the end-user for initializing the jukebox mode of operation of the system Sj, which is for displaying and listening to a music video clip selection. As mentioned previously, the first, second, and third display areas 201, 202, and 203 are displayed by using a part of the browser software installed on the controller box 12 that accompanies the digital display device 1.

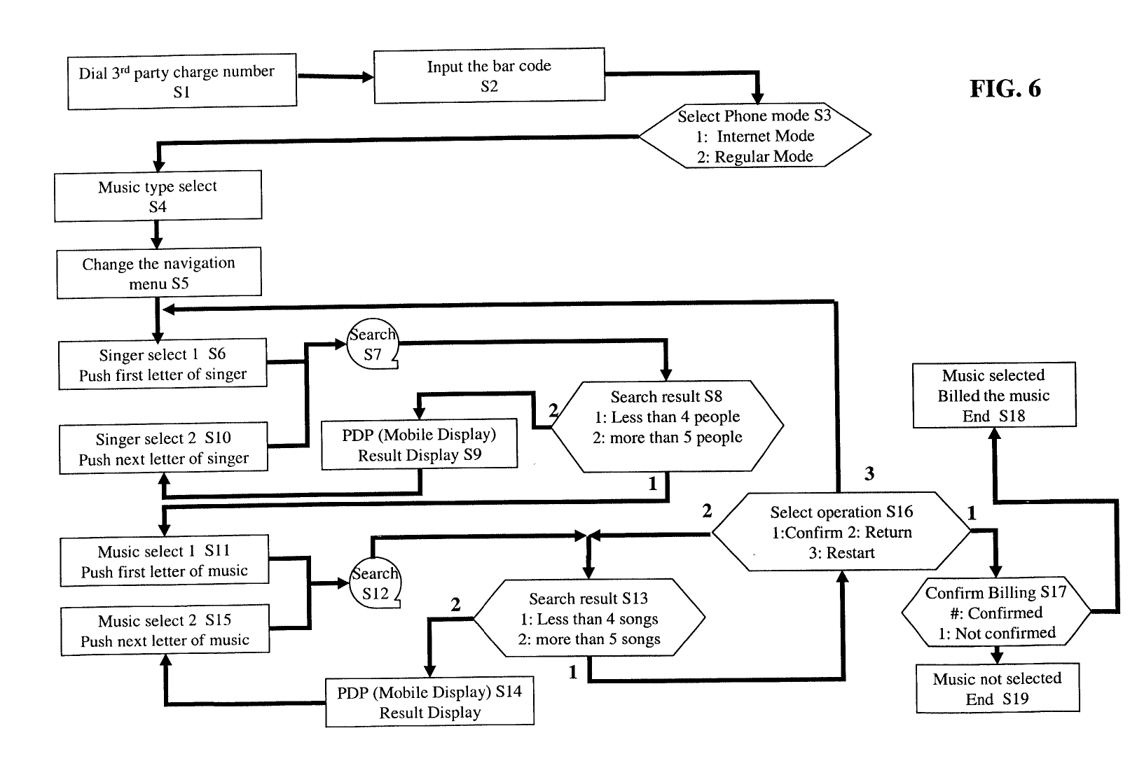

FIG. 6 is an illustrative example of a process of making the music selection in accordance with one embodiment of the present invention.

In operation s1, the end-user dials the third party toll phone number 21 displayed on the first area 201 in the PDP 11 with his or her mobile phone 41 or the PHS phone 43. At this time, in the jukebox mode, the distribution server 51 provides the navigation menu 23 and the sample music video clip 24 to the digital display device 1 as shown in FIG. 3. In case of the combined use of the jukebox mode and the commercial mode, the distribution server 51 provides the navigation menu 23 and the advertisements to the digital display device 1 as shown in FIG. 4. The distribution server 51 stores navigation menu information for every digital display device 1 (i.e. for every bar code number) and the navigation menu 23 is provided to the digital display device 1 based on the navigation menu information. Also, the distribution server 51 provides the sample music video clip 11 that is picked up at random from music data server 55.

In operation 52, the distribution server 51 sends a voice message such as “Please enter the bar code number displayed the monitor with your phone keypad” to the end-user via the DTFM server 52 and telephone station 61. After the end-user enters the bar code number 22, the distribution server 51 recognizes the location where information such as the navigation menu 23 and the music visual video clip 24 should be delivered (i.e. recognizes the establishment where the display device 1 is installed). In operation s3, the distribution server 51 provides an indication that lets the end-user know to select the mode of his or her mobile phone 41 through the navigation menu 23. Additionally, the distribution server 51 also provides a voice message to prompt to the user to enter data or to look at the PDP 11 using the mobile phone 41. Then, the end-user selects the phone mode, Internet mode or regular mode of operation. The Internet mode is a mode that is available if the mobile phone 41 has a Internet connection function and can display a web site. The regular mode is a mode that is available if the mobile phone 41 has only a call function (i.e. usual telephone). If the end-user selects the Internet mode, the distribution server 51 provides the navigation menu to not only the digital display device 1 but also to the mobile phone 41. A navigation menu for the mobile phone 41 is customized to adapt to a display size of the mobile phone 41. If the end-user selects the regular mode, the distribution server 51 provides the navigation menu only to the digital display device 1.

Next, in operation 54, the distribution server 51 provide a navigation menu 23 for selecting a style of the music to be displayed on the digital display device 1, and also provides a voice message such as “Please select a genre” to the mobile phone 41. Therefore, the end-user is prompted to select the style of music that he or she desires to display and hear. Using the keypad 42 of the mobile phone 41, the end-user then makes a music style selection from the numbered music selection offered by the navigation menu 23. For example, if the end-user selects the “5. JAZZ” by pushing the number 5 button on the keypad 42, the distribution server 51 highlights the “5. JAZZ”. Then, the distribution server 51 temporarily memorizes the music style selection.

In operation s5, the distribution server 51 changes the navigation menu 23 from the navigation menu 23 for selecting the music style to a navigation menu 23 for selecting a singer (an artist) based on the music style selection made by the end-user. Then, the distribution server 51 provides the navigation menu for selecting the singer. If the end-user uses the mobile phone 41 with the Internet mode, the distribution server 51 also provides the navigation menu for selecting the singer to the mobile phone 41. Next, in operation s6, the end-user is prompted to select the artist or singer. In one example, the end-user uses the keypad 42 of the mobile phone 41 to select a first letter that corresponds to a singer's or an artist's name which the end-user wants to request. In operation s7, the distribution server 51 searches the music data server 55 for the entire artist's names that match the end-user's selection of a music style and identifies the first letter of the singer or the artist. For example, if the end-user selects a genre “ROCK” and then selects a first letter “M”, the distribution server 51 will search for all artists that begin with the letter “M” and that are classified in the genre of “ROCK”.

In operation s8, the distribution server 51 determines whether a search result found less than four singers or four or more singers. If the search result found four or more singers, the results are displayed (operation s9) and the end-user is prompted to enter the second letter of the artist's or singer's name to narrow the search criteria and limit the search results (operation s10). Then, operations s7, s8, s9 and s10 are repeated until the desired search results are narrowed to less than four singers. Then, in operation s11, the distribution server 51 provides a navigation menu for selecting a title of a song to be displayed on the digital display device 1. Also, if the mobile phone 41 has the Internet connection feature, the distribution server 51 provides the navigation menu 32 for the mobile phone 41 and a voice message to prompt the selection of the title. For example, the end-user may be prompted to enter a first letter of the title with the keypad 42 of the mobile phone 41.

In operation s12, the distribution server 51 again searches the music data server 55 for song that matches the search criteria which is based on the singer's name obtained in the singer search in operation s7 and the first letter of the song inputted by the end-user in operation s11. In operation s13, the distribution server 51 determines whether the number of matches in the search result for the song is less than four or four or more. If the matches found are four or more, the results are displayed (operation s14), and the end-user is requested to enter a second letter of the song to narrow the search criteria and limit the search results (operation s15). Again operations s12, s13, s14, and s15 are repeated until the desired search results are narrowed to less than four songs. Once the desired results are achieved, the end-user either confirms the music selection, returns to operation s13 for selecting again another one of the songs from the search result of songs, or returns to operation s6 to begin the search over again. (Operation s16). If the song selection is confirmed in operation 16, a routine for changing the end-user for the use of the system Sj is conducted. (Operation s17). Specifically, the end-user is prompted to confirm to bill the fees related to the use of the system Sj and for downloading the song. If the fees are confirmed, the music video clip 24 (audiovisual data) is transmitted from the music data server 55 to the digital display device 1 for viewing by the end-user, and the billing information is sent to the billing server 62 in the telecommunication center 6. (Operation s18). Also, the billing server 62 transfers the billing information to the account server 53 in the central database 5 for the purpose of tallying up the fees. Additionally, the end-user or owner of the mobile phone 41 will be billed directly for the use of the system Sj based on the billing information. Then, the mobile telephone connection 72 is disconnected automatically by the distribution server 51. On the other hand, if the end-user does not confirm acceptance of or fails to confirm acceptance with a predetermined period of the operation s17, the distribution server 51 determines that the song is not selected and disconnects the mobile telephone connection 72 (operation s19).

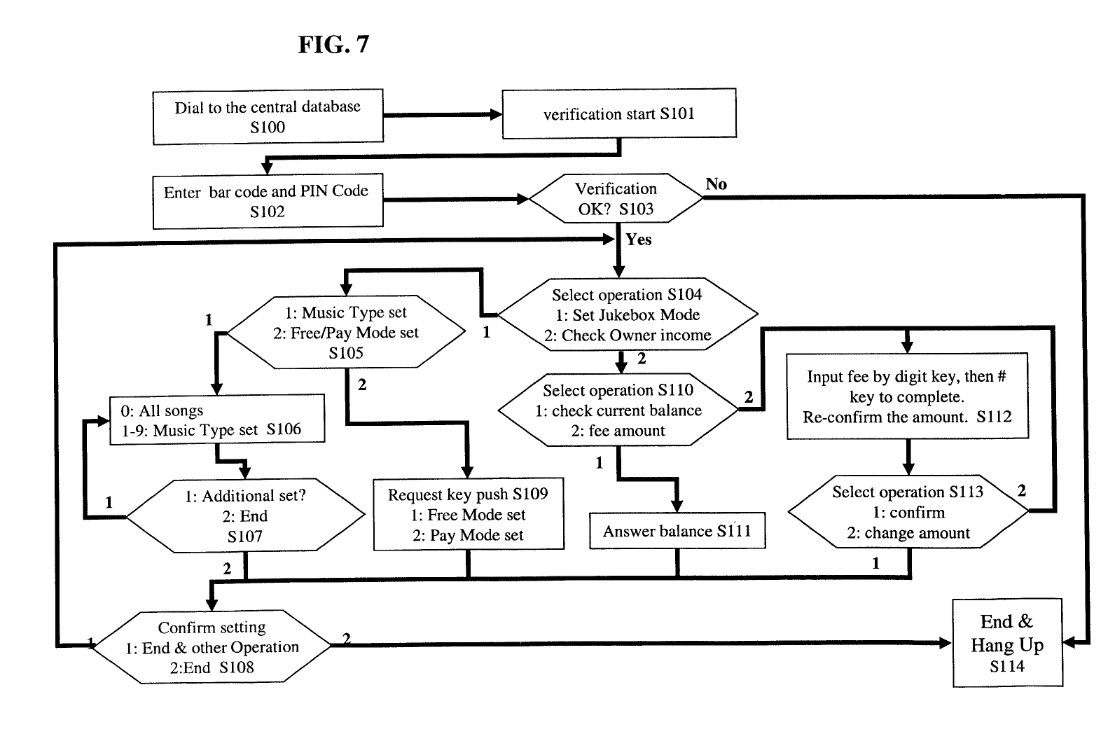

FIG. 7 illustrates an exemplary, non-limiting process for adjusting system settings. An illustrative example of adjusting system settings is adjusting the genre of a music video clip (audiovisual data) available for selection by said end-user in the navigation menu 23 and the fee for the song such adjustments will be described below.

In operation s100, the owner of the commercial establishment, where the digital display device 1 is installed, initializes communication with the central database 5 by calling a telephone number that creates a connection with the distribution server 51 and the accounting system server 53 in the central database 5. The number called by the owner is preferably a different from the number 21 displayed on the digital display device 1. This connection is made between the owner's phone and the central database 5 via the PHS home terminal 47, PHS telephone connection 71, telephone station server 61 in the telecommunication center 6, and the DTMF server 52 in the central database 5. Once the distribution server 51 confirms the call from the owner, it performs verification routine in operation s101 to confirm that the owner has the authority to adjust settings. For example, the owner may need to input a proper user via the PHS. Then, the owner is prompted to enter the bar code number 15 (i.e. the bar code number displayed on the digital display device 1) and a PIN (Personal Identification Number) code. In this situation, the distribution server 51 provides a voice message to the owner phone 46 to prompt an entry. The bar code and the PIN code entered by the owner are matched to a stored PIN code. (Operation s103). If entered PIN code equals the stored PIN code, the owner is prompted to select a “set JukeBox Mode” or option “Check Owner Income” option. (Operation s104). If the former is selected, in operation s105, the owner is prompted to select whether he or she wants to adjust the “Music Type” setting or “Payment Mode” setting. If the music type setting is selected, then the owner can select what songs or music types to change. (Operation s106). For example, if the owner would like to enable all types of music to be requested by an end-user, the owner selects the “All song” option. As a result, the end-user can selectively request a song from all the songs stored in the music data server 55 in the central database 5. On the other hand, if the owner wants to restrict music song that can be requested, the owner selects a specific music-type. For example, if the user wants to enable the user to select from songs identified by the music type “4” (e.g. country music songs), the user may input a “4”. Afterwards, in operation s107, the user is provided with the options of permitting additional types of songs to be requested (by inputting a “1”) or not permitting additional types of songs to be requested (by inputting a “2”). If the user inputs a “1”, the process returns to operation s106, and the user can selectively permit another type of songs to be requested (in addition to the type of songs previously permitted). On the other hand, if the owner permits all songs to be requested by the end-user (i.e. if the owner inputs a “0” in operation S106), the owner inputs a “2” to select the “End” option in operation s107. After the music type changes are made, the owner confirms such changes in operation s108. If the owner needs to make additional adjustments, the user confirms the music type changes by inputting a “1” to select the “End & other Operation” option. In such case, the process and returns to operation s104 to make additional adjustments to the system settings. If the owner does not need to make additional adjustments, the user inputs a “2” to select the “End” option, and the call is terminated (operation s114). Then, the navigation menu information stored in the distribution server 51 is rewritten based on the music type changes input by the user. Therefore, the navigation menu 23 that incorporates the music-type changes will be displayed the next time it is accessed.

In operation s105, if the owner selects the “Free/Pay Mode set” option, the owner is able to select whether the system operates in a “Free Mode” option or “Pay Mode” option. In the “Free Mode”, the end-user is not charged a fee for using the system or requesting a song. In such a case, the owner may pay a flat rate for enabling the end-users unlimited use of the system or may pay a use fee and/or a request fee depending on the amount of time that the end-users use the system and/or the number of songs actually requested by the end users. When the “Free Mode” option is selected, corresponding data is sent to the account system server 53. The accounting server 53 then informs the billing server 62 not to charge the end-users a fee for using the system or requesting songs. In the “Pay Mode”, the end-users are charged a fee for using the system and/or requesting songs in the manner described above.

If the owner selects “Check Owner Income” option in operation s104, the owner can check the current balance earned by the jukebox system Sj or can change the actual fee amount charged per each music request by an end-user. (Operation s10) If the owner selects the “Check Owner Balance” option in operation s110, the balance of income generated by the system S to date can be verified (operation s111). In the operation s111, the account server 53 calculates a total income for a predetermined period of time (or a time period input by the owner). The total income is calculated based on the account information stored in the server 53. Then, the owner is informed of the total income by a voice message via the DTMF server 52 and the phone 45. If the owner selects the “Fee Amount” option in operation s110, the owner can change the amount of the fee charged to the end-user by entering a new fee amount when prompted by the system (operation s112). Afterwards, in operation s113, the owner is prompted to confirm the change to the fee amount (by inputting “1”) or to make additional changes by returning to operation s112 (by inputting “2”). When the user inputs a “1”in operation s113 to confirm the change, the process proceeds to operation s108. After the fee amount is changed, the new fee amount is stored in the account system server 53, and the account system server 53 informs the billing server 62 of the new amount via the connection 74. Therefore, the billing server 62 can charge the fee for the end-user using the system and/or requesting a song based on this new fee amount.

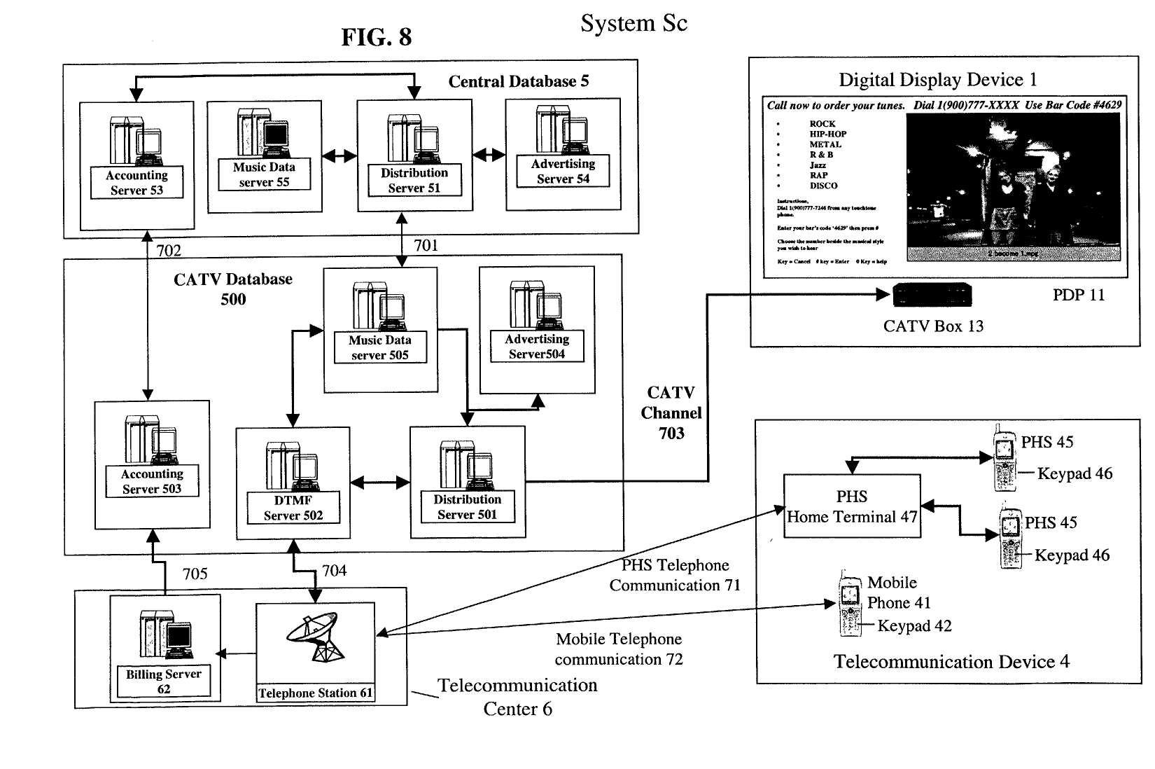

FIG. 8 illustrates another embodiment of the present invention. In accordance with FIG. 8, the communication connection for transmitting the music video clip at the request of the end-user to the digital display device 1 is a standard cable TV connection or CATV channel 703. The cable TV connection 703 establishes a connection between a CATV box 13 of the type offered by a cable provider and a cable TV database 500. The configuration of the cable TV database 500 is similar to the configuration of the central database 5 described in FIG. 2. In other words, the cable TV database 500 comprises a distribution server 501 for distributing the music video clip to the CATV 13 via the CATV channel 703 and searches for requested music data in the music data server 505. The distribution server 501 then transmits the requested music visual clip (audiovisual data) to be displayed on the digital display device 1. The CATV database 5 also comprises a DTMF server 502 for receiving the call from the telephone station 61 in the telecommunication center 6 and comprises an account system server 503 and an Internet advertising server 504. As mentioned previously, the music video clip is received by the CATV box 13 that is mounted proximate to the digital display device 1. The digital display device 1 can be a television set, a personal computer (PC) or a PDP system located in a commercial establishment such as a bar, restaurant, coffee shop, etc. The central database 5 in the embodiment illustrated in FIG. 8 is directly connection to the cable TV database 500 via a connection 701 such as a telephone line. The distribution server 51 of the central database 5 transmits updated audiovisual data to the music data server 55 located in the CATV database 500. For example, if the central database 5 will store all newly released music video clips (audiovisual data) in its music data server 55. The newly released music video clip is transferred to the music data server 504 in the CATV database 500 through the distribution server 51 and the connection 701. If the CATV company wishes to update their music data server 504 to include newly released music that can be offered to an end-user for viewing, the newly released music video clip is transmitted via the distribution server 51 of the central database 5 to the music data server 504 in the CATV database 500. In FIG. 7, the accounting server 53 of the central database 5 communicates with the accounting server 503 of the CATV database 500 through the connection 702 to obtain and store account information for each end-user that uses the jukebox system. Additionally, the accounting server 53 in the central database 5 maintains an accurate account of charges for all music updates received by the CATV database 500 from the central database 5. Furthermore, the accounting server 503 communicates with the billing server 62 in the telecommunication center 6 via a connection 705. The billing information is forwarded to the accounting system server 53 and 503.

The procedure to select a song with the mobile phone 41 is as same way as mentioned above the previous embodiment. The distribution server 504 then transmits the music video clip requested via the cable channel 703. The music video clip is received by the CATV box 12 of the digital display device 1. The previous description of the preferred embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents thereof.

What is claimed is:

1. A digital information distribution apparatus comprising:
a digital information server which stores digital information to be distributed;
at least one digital display device for displaying said digital information;
a telecommunication device which requests said digital information;
a first communication pass for communication with said digital information server and said display device;
a second communication pass for communication with said telecommunication device and said digital information server;
wherein said digital information server provides a plurality of menus for making a plurality of selections to display said digital information on said display device via said first communication pass, said selections being made using said telecommunication device and sent to said digital information server via said second communication pass, wherein said digital information selected to be displayed is sent to said digital display device from said digital information server via said second communication pass based on said selections.

2. The digital information distribution apparatus as recited in claim 1, wherein said plurality of menus comprises a first menu and a second menu, and said plurality of selections comprises a first selection and a second selection;
wherein said digital information server provides said first menu for selecting digital information to be displayed on said display device via said first communication pass, said first selection being made using said telecommunication device and sent to said digital information server via said second communication pass, wherein said digital information selected to be displayed is sent to said digital display device from said digital information server via said first communication pass; and
wherein said digital information server provides a said second menu based on said first selection and provides said second menu for selecting digital information to be displayed on said display device via said first communication pass, said second selection being made using said telecommunication device and sent said digital information server via said second communication pass, wherein said digital information selected to be displayed is sent from said digital information server to said digital display device via said first communication pass based on said second selection.

3. The digital information distribution apparatus as recited in claim 2, wherein said first communication pass is a telephone line connection.

4. The digital information distribution apparatus as recited in claim 3, wherein said first communication pass is an Internet.

5. The digital information distribution apparatus as recited in claim 4, wherein said second communication pass comprises a first line between said telecommunication device and a public telephone network, and a second line between said public telephone network and said digital information server.

6. The digital information distribution apparatus as recited in claim 5, wherein a phone number is displayed on said display device, and said second communication pass is active when said phone number is called using said telecommunication device.

7. The digital information distribution apparatus as recited in claim 6, wherein said phone number is a third party charge phone number.

8. The digital information distribution apparatus as recited in claim 7, wherein a predetermined fee is required for requesting said digital information, and said predetermined fee is charged to an owner of said telecommunication device via said third party charge phone number.

9. The digital information distribution apparatus as recited in claim 8, wherein said telecommunication device is a mobile phone.

10. The digital information distribution apparatus as recited in claim 9, wherein said digital information server has a voice message, which prompts a selection of digital information and that corresponds with a particular menu being displayed on said display device;
wherein said voice message is provided to said telecommunication device through said second communication pass.

11. The digital information distribution apparatus as recited in claim 1, wherein said selection is made by pushing a keypad of said mobile device.

12. The digital information distribution apparatus as recited in claim 1, wherein each of display device is connected to said digital information server using said first communication pass, and each display device has identification information.

13. The digital information distribution apparatus as recited in claim 12, wherein said identification information is displayed on said display device.

14. The digital information distribution apparatus as recited in claim 13, wherein said identification information is an identification number that is different for each said display device.

15. The digital information distribution apparatus as recited in claim 14, wherein said identification number entered using said telecommunication device before said selection is made and said digital information server distributes said digital information to said display device.

16. A digital information distribution apparatus comprising:
a digital information server which stores digital information to be distributed;
a digital display device for displaying said digital information;
a telecommunication device for requesting said digital information;
a first communication pass for communication with said digital information server and said display device;
a second communication pass for communication with said telecommunication device and said digital information server via a telecommunication company;
wherein said digital information server provides digital information to said display device via said first communication pass based on a selection, said selection being made using said telecommunication device and sent to said digital information server via said second communication pass, wherein said digital information selected to be displayed is sent from said digital information server to said display device using said first communication pass; and
wherein a predetermined fee is required for providing said digital information and said predetermined fee is charged to an owner of said telecommunication device.

17. The digital information distribution apparatus as recited in claim 16, further comprising:
a billing server that stores in a memory said predetermined fee to be charged to a said owner of said telecommunication device that was used for selecting said digital information;
wherein said billing server prepares a bill based on said predetermined fee to be paid by said owner of said telecommunication device used for selecting said digital information.

18. The digital information distribution apparatus as recited in claim 17, wherein said predetermined fee is stored in said billing server when said selection is made.

19. The digital information distribution apparatus as recited in claim 18, wherein said billing server calculates said predetermined fee during at least one predetermined time period

20. The digital information distribution apparatus as recited in claim 19, wherein;
said billing server stores a call charge made by said telecommunication device, and calculates said predetermined fee and said call charge together during said at least one time period.

21. The digital information distribution apparatus as recited in claim 16, wherein said second communication pass comprises a first line between said telecommunication device and a public telephone network, and a second line between said public telephone network and said digital information server.

22. The digital information distribution apparatus as recited in claim 16, wherein a phone number for requesting said digital information is displayed on said display device;
wherein said second communication pass is active when said phone number is called using said telecommunication device.

23. The digital information distribution apparatus as recited in claim 22, wherein said phone number is a third party charge phone number.

24. The digital information distribution apparatus as recited in claim 23, wherein a predetermined fee is required for requesting said digital information, and
said predetermined fee is charged to an owner of said telecommunication device via said third party charge phone number.

25. A digital audiovisual information distribution apparatus comprising;
a digital audiovisual information server which stores digital audiovisual information to be distributed;
at least one digital display device which displays said digital audiovisual information;
a telecommunication device for requesting said digital audiovisual information;
a first communication pass for communicating with said digital audiovisual information server and said display device;
a second communication pass for communicating with said telecommunication device and said digital audiovisual information server information;
wherein said digital audiovisual information server provides a plurality of menus for making a plurality of selections for displaying said digital audiovisual information using said first communication pass, said selections being made using said telecommunication device and sent to said digital information server via said second communication pass, wherein said digital audiovisual information selected to be displayed is sent to said digital display device from said digital information server via said first communication pass based on said selections.

26. The digital audiovisual information distribution apparatus as recited in claim 25, wherein said plurality of menus comprises a first menu and a second menu, and said plurality of selections comprises a first selection and a second selection;
wherein said digital information server provides said first menu for selecting digital audiovisual information to be displayed on said display device via said first communication pass, said first selection being made using said telecommunication device and sent to said digital information server via said second communication pass, wherein said digital audiovisual information selected to be displayed is sent to said display device from said digital information server via said second communication pass; and
wherein said digital information server provides said second menu based on said first selection and provides said second menu for selecting digital audiovisual information to be displayed on said display device using said first communication pass, said second selection being made using said telecommunication device and sent to said digital information server via said second communication pass, wherein said digital audiovisual information selected to be displayed is sent to said digital display device from said digital information server via said second communication pass based on said selections.

27. The digital audiovisual information distribution apparatus as recited in claim 26, wherein said first menu is for selecting a genre of said digital audiovisual information and said second menu is for selecting a title of said digital audiovisual information;
wherein said digital audiovisual information server searches based on said first and second selection, and provides a selected digital audiovisual information to said display device.

28. The digital audiovisual information distribution apparatus as recited in claim 27, wherein said first communication pass is a telephone line.

29. The digital audiovisual information distribution apparatus as recited in claim 28, wherein said first communication pass is an Internet.

30. The digital audiovisual information distribution apparatus as recited in claim 29, wherein said second communication pass comprises a first line between said telecommunicaiton device and a public telephone network, and, a second line between said public telephone network and said digital audiovisual information server.

31. The digital audiovisual information distribution apparatus as recited in claim 30, wherein a phone number is displayed on said display device;
wherein said second communication pass is active when said phone number is called by said telecommunication device.

32. The digital audiovisual information distribution apparatus as recited in claim 31, wherein said phone number is a third party charge phone number.

33. The digital audiovisual information distribution apparatus as recited in claim 32, wherein a predetermined fee is required for requesting said digital audiovisual information, and
said predetermined fee is charged to an owner of said telecommunication device via said third party charge phone number.

34. The digital audiovisual information distribution apparatus as recited in claim 35, wherein a predetermined fee is required to request said digital audiovisual information, and said predetermined fee is charged to an owner of said telecommunication device

35. The digital audiovisual information distribution apparatus as recited in claim 34, wherein said telecommunication device is a mobile phone.

36. The digital audiovisual information distribution apparatus as recited in claim 35, wherein said digital audiovisual information server has a voice message, which prompts said selection, which corresponds with a menu being displayed on said display device;
wherein said voice message is provided to said telecommunication device using said second communication pass.

37. The digital audiovisual information distribution apparatus as recited in claim 36, wherein said selections being made using a keypad of said telecommunication device.

38. The digital audiovisual information distribution apparatus as recited in claim 37, wherein each of display device is connected to said digital audiovisual information server using said first communication pass;
wherein each display device has identification information.

39. The digital audiovisual information distribution apparatus as recited in claim 38, wherein said identification information is displayed on said display device.

40. The digital audiovisual information distribution apparatus as recited in claim 39, wherein said identification information is an identification number which is different for each said display device.

41. The digital information distribution apparatus as recited in claim 40, wherein said identification number is inputted using said telecommunication device before any selection is made;
wherein said digital information server distributes said digital information to an identified display device.

42. The digital audiovisual information distribution apparatus as recited in claim 41, wherein a predetermined fee is required for requesting said digital audiovisual information, and
said predetermined fee is charged to an owner of said telecommunication device.

43. A digital information distribution apparatus comprising:
a digital information server which stores first digital information and second digital information to be distributed;
at least one display device which displays said first and second digital information;
a telecommunication device which requests said first digital information;
a first communication pass which communicates with said digital information server and said display device;
a second communication pass which communicates with said telecommunication device and said digital information server;
a first mode of operation for providing said first digital information to said display device using said first communication pass based on a selection of said first digital information, said selection being made using said telecommunication device and sent to digital information server via said second communication pass, wherein said first digital information selected to be displayed is sent to said display device from said digital information server using said first communication pass;
a second mode which provides said second digital information to said display device using said second communication pass;
wherein said digital information server switches from said first mode and said second mode at a predetermined time.

44. The digital audiovisual information distribution apparatus as recited in claim 43, wherein said first digital information is digital audiovisual information and said second digital information is digital advertisement information.

45. The digital audiovisual information distribution apparatus as recited in claim 44,
wherein said digital information server provides a menu and audiovisual information when said first mode is operated, and
said digital information server provides said menu and said advertisement information when said second mode is operated.

46. The digital audiovisual information distribution apparatus as recited in claim 45, wherein said menu is for selecting a title of said audiovisual information.

47. The digital audiovisual information distribution apparatus as recited in claim 46, wherein said digital information server switches from said second mode to said first mode based on said selection of said audiovisual information.

48. The digital audiovisual information distribution apparatus as recited in claim 47, wherein said digital information server switches from said first mode to said second mode if no selection is made during a predetermined time period.

49. A method of distributing digital information comprising the steps of:
storing digital information in a memory of a digital information server that is to be distributed;
receiving a request of said stored digital information from a telecommunication device;
establishing a first communication pass between said digital information server and a digital display device;
establishing a second communication pass between said digital information server and said telecommunication device;
selecting said digital information based on said request and
providing said selected digital information on at least one display device;
wherein said digital information server provides a plurality of menus for making a plurality of selections for displaying said digital information on said digital display device using said first communication pass, said request being provided to said digital information server via said second communication pass,
wherein said selected said digital information to be displayed is provided to said digital display device from said digital information server via said first communication pass.

50. The method of distributing digital information according to claim 49, wherein said menu comprises a first menu and a second menu, and said plurality of selections comprises a first selection and a second selection.

51. The method of distribution digital information according to claim 50, further comprising the steps of providing a first menu for making a first selection of digital information to be displayed on said display device via said first communication pass, said selection being made using said telecommunication device and sent to said digital information server via said first communication pass, wherein said digital information selected to be displayed is sent to said display device from said digital information server via said first communication pass; and
providing a second menu based on said first selection for making a second selection of said digital information to be displayed on said digital display device via said first communication pass, said selection being made using said telecommunication device and sent to said digital information server via said second communication pass, wherein said digital information selected to be displayed is sent to said display device from said digital information server via said first communication pass based on said second selection.

52. The method of distributing digital information according to claim 51, wherein said first communication pass is a telephone line connection.

53. The method of distribution digital information according to claim 52, wherein said first communication pass is an Internet connection.

54. The method of distributing digital information according to claim 53, wherein said second communication pass comprises a first line between said mobile device and a public telephone network, and a second line between said public telephone network and said digital information server.

55. The method of distributing digital information according to claim 54, further comprising the step of displaying a phone number on said display device;
wherein said second communication pass is active when said phone number is called using said telecommunication device.

56. The method of distributing digital information according to claim 55, wherein said phone number is a third party charge phone number.

57. The method of distributing digital information according to claim 56, further comprising the step of charging a predetermined fee for requesting said digital information, wherein said predetermined fee is charged to an owner of said telecommunication device via said third party charge phone number.

58. The method of distributing digital information according to claim 57, wherein said telecommunication device comprises a mobile phone.

59. The method of distributing digital information according to claim 58, further comprising the steps of prompting said selection of said digital information by providing a voice message that corresponds with said menu being displayed on said display device;
wherein said voice message is provided by said digital information server and to said telecommunication device using said second communication pass.

60. The method of distributing digital information according to claim 59, wherein said selection is made by pushing a keypad on said telecommunication device.

61. The method of distributing digital information according to claim 60, further comprising the step of identifying each display device operable to communicate with said digital information server by using identification information specific to each said display device;
wherein the identification information for each display device is different.

62. The method of distributing digital information according to claim 61, further comprising the step of entering said identification information for said display device using said telecommunication device before said selection of digital information is made.

63. A method of distributing digital information comprising the steps of:
storing digital information in a memory of a digital information server that is to be distributed;
receiving a request of said stored digital information from a telecommunication device;
establishing a first communication pass between said digital information server and a display device;
establishing a second communication pass between said digital information server and said telecommunication device;
selecting said digital information to be displayed on said display device based on said request;
charging a predetermine fee to an owner of said telecommunication device for selecting said digital information to be displayed on said display device; and
displaying said selected digital information on at least one said display device;
wherein said digital information server provides digital information to said display device via said first communication pass based on a selection, said request being sent to said digital information server via said second communication pass, wherein said digital information selected to be displayed is sent from said digital information server to said display device using said first communication pass.

64. The method of distributing digital information according to claim 63, further comprising the step of storing in a memory of a billing server said predetermined to be charged, wherein said predetermined fee is stored in said billing server when a selection of said digital information is made by said owner.

65. The method of distributing digital information according to claim 64, further comprising the step of preparing a bill containing said predetermined fee to be paid by said owner of said telecommunication device.

66. The method of distributing digital information according to claim 65, wherein said second communication pass comprises a first line between said telecommunication device and a public telephone network, and a second line between said public telephone network and said digital information server.

67. The method of distributing digital information according to claim 66, further comprising the step of displaying a number on said display device for requesting said digital information, wherein said second communication pass is active when said phone number is called using said telecommunication device.

68. The method of distributing digital information according to claim 67, wherein said phone number is a third party charge phone and said third party number is used for requesting said digital information using said telecommunication device.

69. The method of distributing said information according to claim 68, wherein said charging of said predetermined fee to said owner of said telecommunication device is accomplished using said third party number.

70. A method of distributing digital information comprising the steps of:
storing a first digital information and a second digital information in a memory of a digital information server that is to be distributed;
receiving a request of said stored digital information from a telecommunication device;
establishing a first communication pass between said digital information server and a digital display device;
establishing a second communication pass between said digital information server and said telecommunication device;
providing a first mode of operation for sending said first digital information to said display device using said first communication pass based on a selection of said first digital information, said request being provided to said digital information server via said second communication pass, wherein said first digital information is provided to said display device to be displayed via said first communication pass; and
providing a second mode of operation for providing said second digital information to said display device via said second communication pass;
wherein said digital information server switches from said first mode of operation to said second mode of operation after a predetermined time period.

71. The method of distributing digital information according to claim 70, wherein said first digital information is digital audiovisual information and said second digital information is digital advertisement information.

72. The method of distributing digital information according to claim 71, further comprising the steps of providing a menu and said audiovisual digital data in said first mode of operation, and providing said menu and said digital advertisement information in said second mode of operation.

73. The method of distributing digital information according to claim 72, wherein said menu is for selecting a title of said audiovisual information.

74. The method of distributing digital information according to claim 73, further comprising the step of switching from said second mode of operation to said first mode of operation if a selection of said digital audiovisual information is made using said telecommunication device.

75. The method of distribution digital information according to claim 74, further comprising the step of switching from said first mode of operation to said second mode of operation if no said selection is made after a predetermined time period.

76. A method of distributing digital audiovisual information comprising the steps of:
storing digital information in a memory of a digital information server that is to be distributed;
receiving a request of said stored digital information using at least one telecommunication device
establishing a first communication pass between said digital information server and said digital display device;
establishing a second communication pass between said digital information server and said telecommunication device;
providing a plurality of selections for displaying said digital audiovisual information; and
providing said selected digital information on at least one display device,
wherein said digital audiovisual information server provides a plurality of menus for making said plurality of selections for displaying said audiovisual information on said display device via said first communication pass, said request being provided to said digital information server via said second communication pass, wherein said digital audiovisual information selected is provided to said display device to be displayed using said second communication pass.

77. The method of distributing digital information according to claim 76, wherein said plurality of menus comprises a first and second menu and said plurality of sections comprises a first and second selection.

78. The method of distributing audiovisual information according to claim 77, further comprising the steps of making a first selection of said digital audiovisual data to be displayed on said display device using said first menu, said selection being made using said telecommunication device and sent to said digital information server via said second communication pass, wherein said digital audiovisual information selected is sent to said display device to be displayed from said digital information server using said first communication pass.

79. The method of distributing audiovisual information according to claim 78, further comprising the steps of making a second selection of said digital audiovisual data to be displayed on said display device using said second menu, said second selection being made using said telecommunication device and sent to said digital information server via said second communication pass, wherein said second menu is based on said first selection and said digital audiovisual information is sent to said display device from said digital information server based on said second selection using via said first communication pass

80. The method of distributing digital audiovisual information according to claim 79, wherein said first menu is for selecting a genre of said digital audiovisual information and said second menu is for selecting a title of said digital audiovisual information, wherein said digital audiovisual information server searches the stored digital audiovisual information based on sand first and second selections, and provides the selected digital audiovisual information to said display device.

81. The method of distributing digital audiovisual information according to claim 80 wherein said first communication pass is a telephone line connection.

82. The method of distributing digital audiovisual information according to claim 81, wherein said first communication pass is an internet connection.

83. The method of distributing digital audiovisual information according to claim 82, wherein said second communication pass comprises a first line between said mobile device and a public telephone network, and a second line between said public telephone network and said digital information server.

84. The method of distributing digital audiovisual information according to claim 83, further comprising the step of displaying a phone number on said display device, wherein said second communication pass is active when said phone number is called using said telecommunication device.

85. The method of distributing digital audiovisual information according to claim 84, wherein said phone number is a third party charge phone number.

86. The method of distributing digital audiovisual information according to claim 85, further comprising the step of charging a predetermined fee for requesting said digital information, wherein said predetermined fee is charged to an owner of said telecommunication device via said third party charge phone number.

87. The method of distributing digital audiovisual information according to claim 86, wherein said telecommunication device comprises a mobile phone.

88. The method of distributing digital audiovisual information according to claim 87, further comprising the steps of prompting said selection of said digital audiovisual information by providing a voice message that corresponds with said menu being displayed on said display device, wherein said voice message is provided by said digital information server and to said telecommunication device using said second communication pass.

89. The method of distributing digital audiovisual information according to claim 88, wherein said selection is made by pushing a keypad on said telecommunication device.

90. The method of distributing digital audiovisual information according to claim 89, further comprising the step of identifying each display device operable to communicate with said digital information server by using identification information specific to each said display device, wherein the identification information for each display device is different.

91. The method of distributing digital audiovisual information according to claim 90, further comprising the step of entering said identification information for said display device using said telecommunication device before said selection of digital information is made.
